(19) United States
(12) Patent Application Publication
(10) Pub. No.: US 2017/0195262 A1
(43) Pub. Date: Jul. 6, 2017

(54) METHOD OF ORGANIZING DIALOG WITH THE USE OF FILLABLE FORMS

(71) Applicant: Middleware, Inc., Redwood City, CA (US)

(72) Inventor: Oleksandr Vityaz, Dnipropetrovsk (UA)

(21) Appl. No.: 15/167,351

(22) Filed: May 27, 2016

Related U.S. Application Data
(60) Provisional application No. 62/166,715, filed on May 27, 2015.

(51) Int. Cl. H04L 12/58; G06N 5/04; G06F 17/24; G06F 17/30

(52) U.S. Cl. CPC H04L 51/04; G06F 17/30371; G06N 5/04; G06F 17/243

(57) ABSTRACT

Network dialog uses electronically fillable forms, whereby messaging provides structured input, for example, to enable automated processing of transmitted data without dialog termination. Improved information transmission method advantageously enhances efficiency of written communication between dialog participants, increased communication speed, simplifies communication process, reduces errors during information input and transfer, and generally improves communication quality between dialog participants by managing dialog scenario adaptively and/or predictably according to form questions posted, and results presented accordingly in external systems.

### CROSS-REFERENCE TO RELATED APPLICATION

This application claims priority to U.S. Application No. 62/166,715 for “Method of Organizing Dialog with the Use of Fillable Forms”, filed on May 27, 2015, which is incorporated herein by reference.

### FIELD OF INVENTION

The invention pertains generally to the field of digital communications, and more particularly to electronic messaging and dialog via a telecommunications network.

### BACKGROUND OF INVENTION

Conventional chat or messaging communications among users in a digital network often require transmission of alphanumeric, text, or other bulky data from one dialog participant to another. Data transfers requested via manual input of information in a program text window designed for chat dialogs, in particular, suffer various deficiencies, such as: inadequate structure of text field data, large variety of presentation formats of user input data, time-consuming procedures for receiving information due to data transfer from chat window to other information systems, as well as errors arising during process of manual text input and data transfer. Thus, there is need for improved dialog in network communications.

### SUMMARY

The invention resides in enabling electronic dialog predictably and/or adaptively using fillable forms, i.e., by modifying messaging to provide structured input, thereby automating processing of transmitted data without dialog termination.

Advantageously, form-structured information transmission enhances efficiency of written communication between dialog participants, increased communication speed, simplifies communication process, reduces errors during information input and transfer, and improves communication quality between dialog participants by managing dialog scenario according to form questions posted, and results presented accordingly in external systems.

### BRIEF DESCRIPTION OF FIGURES

FIG. 1 illustrates a representative scheme of dialog, for example, between customer bank contact center operator regarding blocking of payment card lost by the customer.

FIG. 2 illustrates one or more aspects of the present invention via schematic presentation of computer-automated network communication method steps using one or more forms in chat dialog, for example, between customer and bank contact center operator.

FIG. 3 illustrates one or more aspects of the present invention via schematic presentation of computer-automated network communication method steps using one or more forms in chat dialog, for example, between customer and bank contact center operator regarding blocking of payment card lost by the customer, whereby the operator uses structured form-based communication with the customer.

FIG. 4 illustrates one or more aspects of the present invention via schematic presentation of computer-automated network communication method steps using one or more forms in chat dialog, for example, between customer and bank contact center operator regarding blocking of payment card lost by the customer, whereby fully automated customer communication sends a sequence of forms.

### DETAILED DESCRIPTION

Generally, software-automated apparatus and/or method is provided for one or more computer and/or network instant messaging programs that transmit text and/or other electronic file or media formats between program users. These programs may be used for personal communication and/or text dialogs, for example, between customers and suppliers in different type of “client” business/customer/group interaction, e.g., B2B, B2C, C2C, B2G, G2B, etc.

Preferably, computer-automated method and/or apparatus organizes dialog using fillable forms by electronically configuring a first processor associated with a first dialog participant coupled to a network according to at least one fillable form for structured participant communication, and electronically configuring a second processor associated with a second dialog participant coupled to the network according to at least one fillable form for structured participant communication, whereby a structured dialog between the first and second participants is enabled automatically by a network controller according to at least one fillable form, without terminating the structured dialog. Accordingly, the network controller manages the structured dialog according to a set of form questions posted on at least one fillable form, thereby simplifying communication between dialog participants.

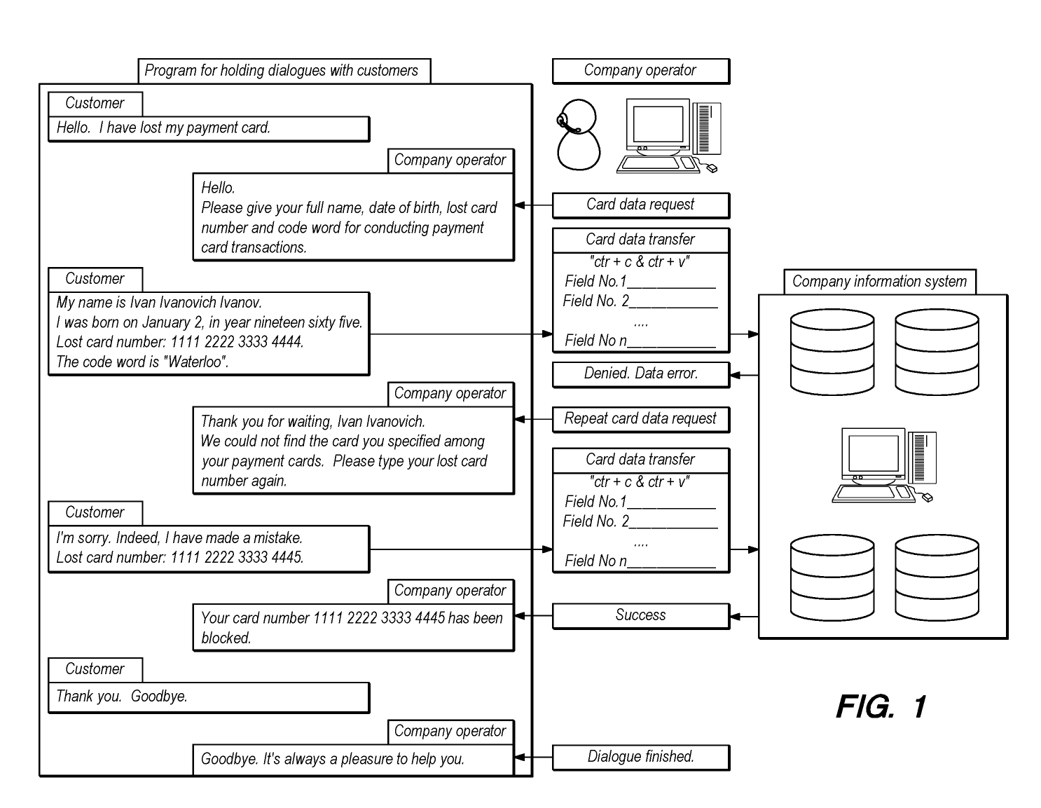

FIG. 1 illustrates a representative scheme of dialog, for example, between customer bank contact center operator regarding blocking of payment card lost by the customer. As shown for typical dialog between bank customer and contact center, conventional communication among users in the form of chat dialogs often require transmission of bulky alphanumeric data from one dialog participant to another. FIG. 1 shows blocking of a payment card lost by the customer, in particular:
1) information requested by bank represented in different formats;
2) use of simple text field for data input not allowing either party to predefine for customer conveniently the format of transmitted data, causing complications in data usage by contact center operator, e.g., entering numeric information in words, etc.;
3) contact center operator being forced to interpret and transfer manually, or in best-case scenario using information copying methods, such as key combinations “ctrl-c” and “ctrl-v”, the information received in chat dialog program to bank's programs with capacity to process customer and transaction data; and
4) errors made in course of data input and interpretation by operator making necessary to repeat requesting and receiving information from customer.

Thus, such transfer of requested data typically via manual input of information in program text window designed for chat dialogs has various deficiencies, such as:
1) lack of structure of text field data;
2) various presentation formats of user input data, e.g. numerous available data presentation formats;
3) time-consuming procedure for received information processing due to need to transfer data from chat window to other information systems; and
4) errors in process of manual text input and data transfer.

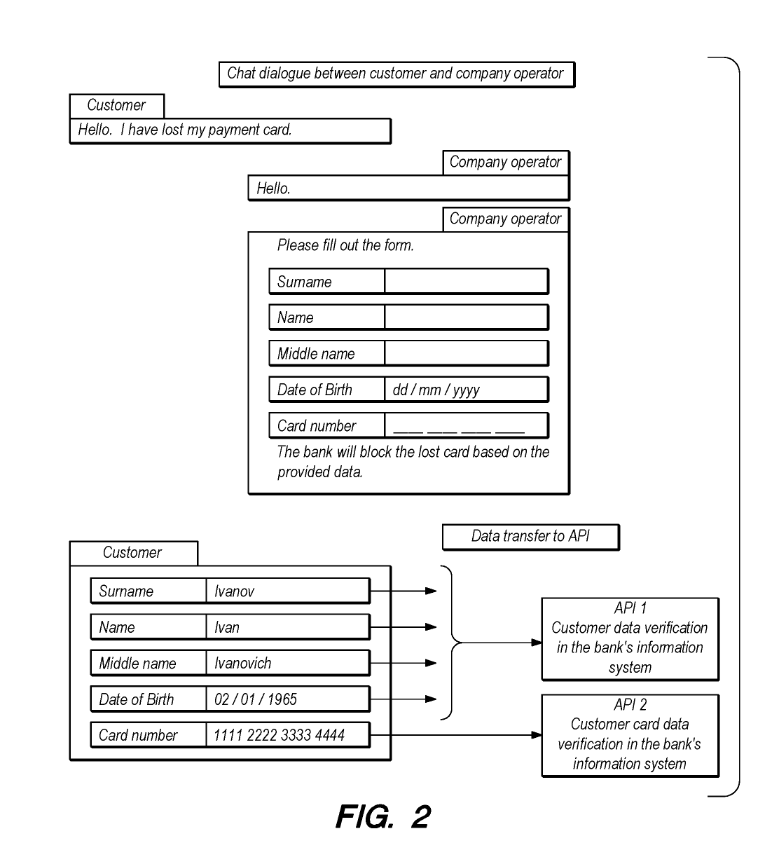

Significantly in comparison, FIG. 2 illustrates one or more distinctive aspects of the present invention via schematic presentation of computer-automated network communication method steps using one or more forms automated during chat dialog, for example, between customer and bank contact center operator. Preferably novel approach automates information input using structured messaging, thereby enabling processing of transmitted data without dialog termination.

FIG. 2 shows schematically using forms in chat dialog between customer and bank contact center operator, for example, whereby sample form indicates that after bank contact center operator identifies main point of customer inquiry, operator obtains data by offering customer to fill-out questionnaire form with preset data format, instead of posing sequence of questions inefficiently.

Preferably, automated form-filling transfers input data using automated application programming interface (API), without operator involvement and corresponding delay, thereby transmitting such data to company information system automatically according to set processing algorithm, thus giving efficient operator access to additional information. Optionally, data from different form fields is transmitted to one or more sub-programs (e.g., API, API1, API2, API3, etc.) connected with one or different parts of information system. And in this automated approach, one or more additional forms may be opened to facilitate information input for further processing.

Advantageously, such fillable form structured information input, transmission and processing approach serves to:
1) enhance efficiency of written communication between dialog participants
   via increased communication speed;
   simplification of communication process; and
   reduction of errors in process of information input and transfer.
2) improve quality of communication between dialog participants via dialog scenario management, e.g., sequencing questions posed, such as form demonstration, and processing results presented in external systems.

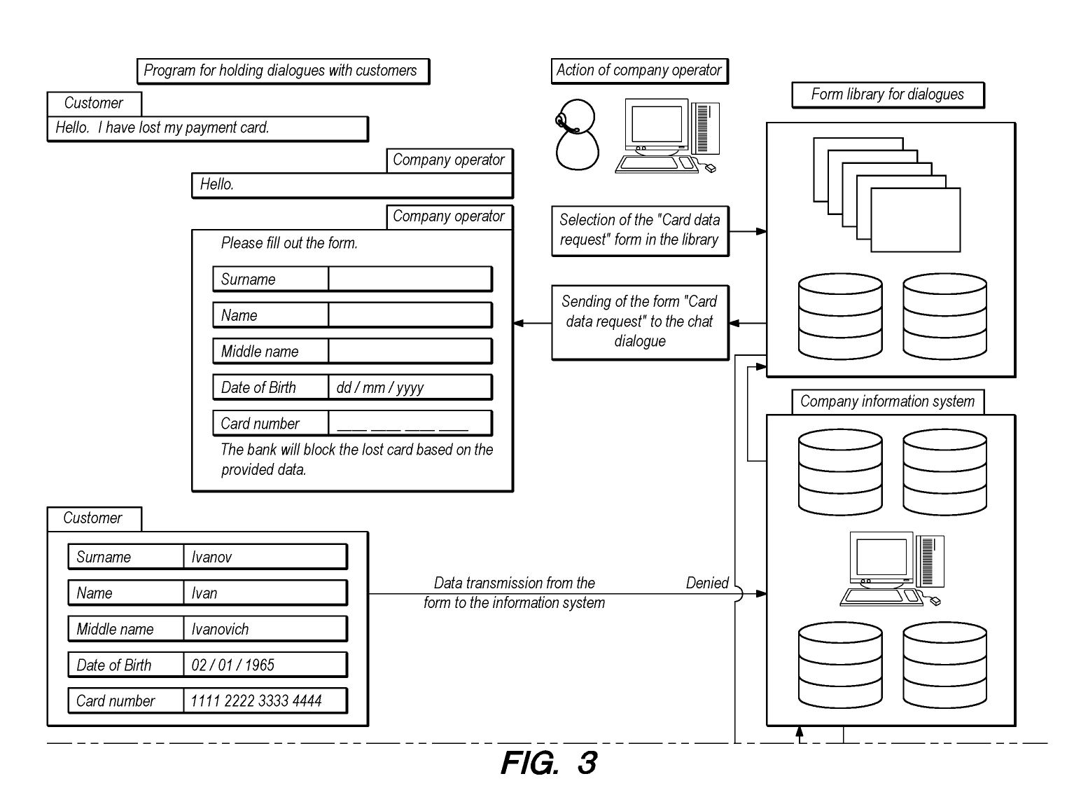

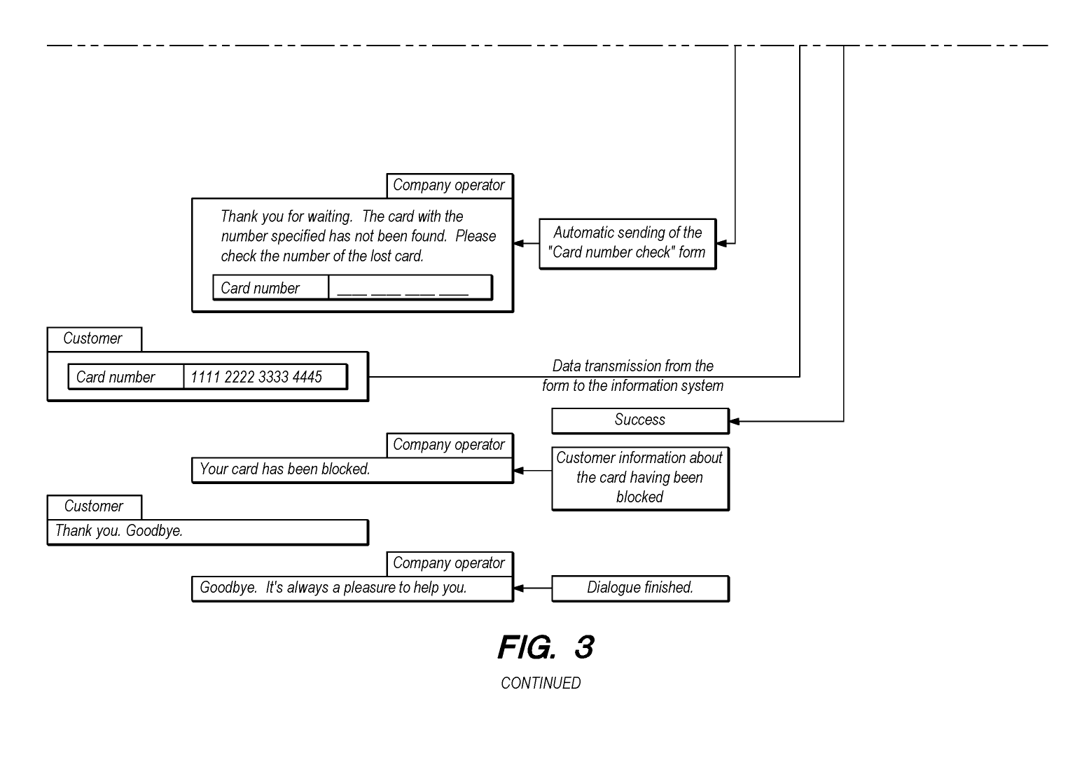

FIG. 3 illustrates one or more aspects of the present invention via schematic presentation of computer-automated network communication method steps using one or more forms in chat dialog, for example, between customer and bank contact center operator regarding blocking of payment card lost by the customer, whereby the operator uses structured form-based communication with the customer.

FIG. 3 dialog steps are similarly comparable to that shown in FIG. 1 in terms of content; however, there are significantly distinctive aspects with regard to predictive and/or adaptive FIG. 3 dialog, notably per following innovative benefits:
1) contact center operator performs fewer operations, and types less text due to automated pre-fillable form sending capability that eliminates redundant entry;
2) customer provides data in required structured format, i.e., not freely unstructured data;
3) data transferred directly from customer to information system, bypassing data interpretation and copying by operator;
4) revision of incorrect data (e.g., form “Card Number Check” sent automatically without operator involvement according to relevant API function dealing with payment card data accuracy checks); and
5) forms used are placed for operator conveniently in form library in company information system.

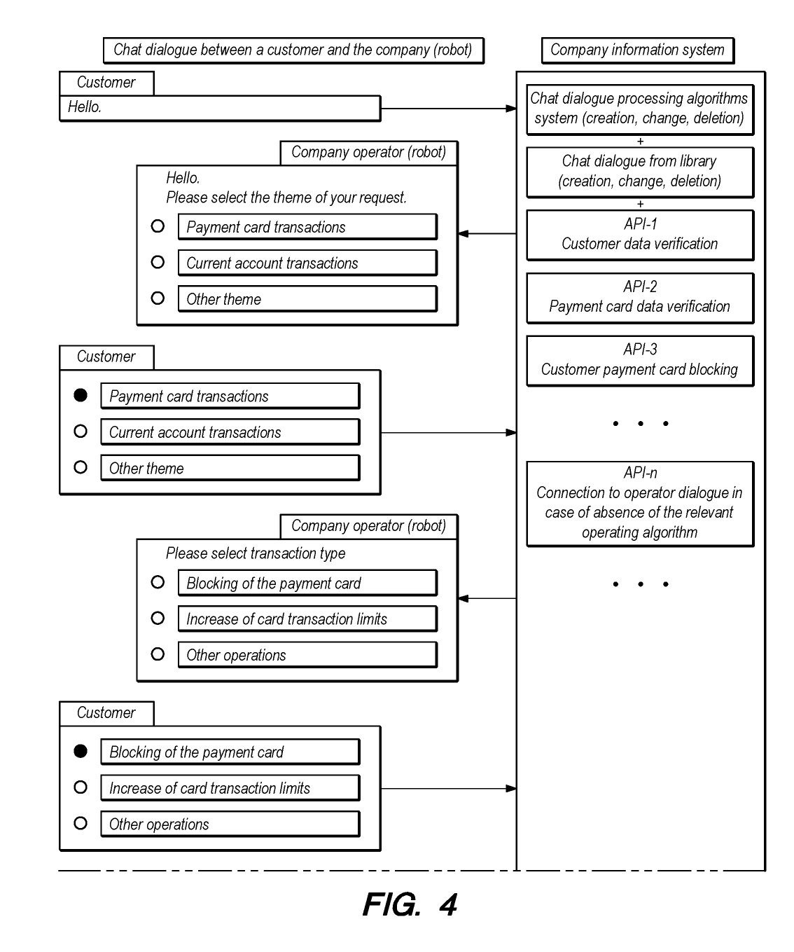

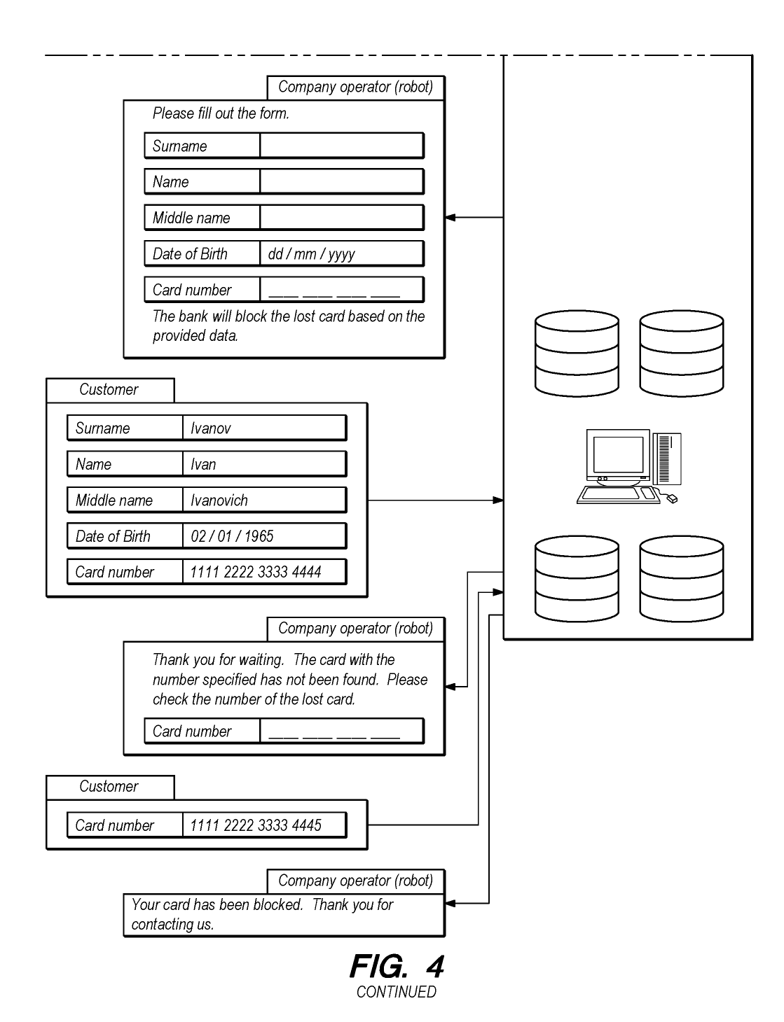

Additionally, automating dialog management via structured messaging using chat forms may be implemented robotically via sequence of forms managed according to previous user-created algorithm with API-processed fields, thereby allowing yet further predictive and/or adaptive automation of the communications process. FIG. 4 illustrates one or more aspects of the present invention via schematic presentation of computer-automated network communication method steps using one or more forms sequentially in robot manner in chat dialog, for example, between customer and bank contact center operator regarding blocking of payment card lost by the customer, whereby fully automated customer communication sends a sequence of forms robotically.

FIG. 4 dialog steps are similarly comparable to those shown in FIGS. 1 and 3 in terms of content; however, there are significantly distinctive aspects with regard to robotically automated sequencing of forms in FIG. 4 dialog, notably per following innovative benefits:
1) dialog is maintained without involving operator due to organized functionality of chat dialog algorithm processing and availability of forms library;
2) dialog algorithm is chosen online based on information previously provided by customer, both in data form and option selection; and
3) depending on information received and results of processing the same with API, the dialog processing algorithm addresses different APIs, including the API for calling bank contact center operator.

Foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents. It is contemplated herein that automated approach for improving form-based messaging is embodied electronically in one or more computing devices accessible in one or more coupled digital networks, such as processors, controllers, servers, as well as wireless mobile devices such as cellular/smartphones, and various internet-of-things (IOT) type devices enabled with network communication and programmable capability.

1. Computer-automated method for organizing dialog using fillable forms comprising steps:
electronically configuring a first processor associated with a first dialog participant coupled to a network according to at least one fillable form for structured participant communication; and
electronically configuring a second processor associated with a second dialog participant coupled to the network according to at least one fillable form for structured participant communication,
whereby a structured dialog between the first and second participants is enabled automatically by a network controller according to at least one fillable form predictably or adaptively without terminating the structured dialog.

2. Method of claim 1 wherein the network controller manages the structured dialog according to a set of form questions posted on at least one fillable form, thereby simplifying communication between dialog participants.

3. Method of claim 1 wherein the network controller manages the structured dialog efficiently such that data is transferable directly from customer to information system without data interpretation or copying by the network controller or information system operator.

4. Method of claim 1 wherein the network controller manages the structured dialog efficiently such that incorrect data is automatically revised by the network controller or structured form application.

5. Method of claim 1 wherein the network controller manages the structured dialog efficiently such that at least one form is stored in a form library for customer or information system operator access.

6. Method of claim 1 wherein the network controller manages the structured dialog robotically using a sequence of fillable forms without operator or network controller involvement.

7. Method of claim 1 wherein the network controller manages the structured dialog adaptively or predictably according to a network-accessible dialog algorithm using customer data based on prior form input or option selection.

8. Method of claim 1 wherein the network controller manages the structured dialog adaptively or predictably depending on information received and results of processing one or more application program interface (API).

9. Computer-automated apparatus for organizing dialog using fillable forms comprising:
means for electronically configuring a first processor associated with a first dialog participant coupled to a network according to at least one fillable form for structured participant communication; and
means for electronically configuring a second processor associated with a second dialog participant coupled to the network according to at least one fillable form for structured participant communication,
whereby a structured dialog between the first and second participants is enabled automatically by a network controller according to at least one fillable form predictably or adaptively without terminating the structured dialog.

10. Apparatus of claim 9 wherein the network controller manages the structured dialog according to a set of form questions posted on at least one fillable form, thereby simplifying communication between dialog participants.

11. Apparatus of claim 9 wherein the network controller manages the structured dialog efficiently such that data is transferable directly from customer to information system without data interpretation or copying by the network controller or information system operator.

12. Apparatus of claim 9 wherein the network controller manages the structured dialog efficiently such that at least one form is stored in a form library for customer or information system operator access.

13. Apparatus of claim 9 wherein the network controller manages the structured dialog robotically using a sequence of fillable forms without operator or network controller involvement.

14. Apparatus of claim 9 wherein the network controller manages the structured dialog adaptively or predictably according to a network-accessible dialog algorithm using customer data based on prior form input or option selection.

15. Apparatus of claim 9 wherein the network controller manages the structured dialog adaptively or predictably depending on information received and results of processing one or more application program interface (API).

16. Multi-processor system for organizing dialog using fillable forms comprising:
a first processor associated with a first dialog participant coupled to a network according to at least one fillable form for structured participant communication; and
a second processor associated with a second dialog participant coupled to the network according to at least one fillable form for structured participant communication,
whereby a structured dialog between the first and second participants is enabled automatically according to at least one fillable form predictably or adaptively without terminating the structured dialog.

17. System of claim 16 wherein the structured dialog is enabled automatically according to a set of form questions posted on at least one fillable form, thereby simplifying communication between dialog participants.

18. System of claim 16 wherein the structured dialog is enabled automatically such that data is transferable directly from customer to information system without data interpretation or copying by a network controller or information system operator.

19. System of claim 16 wherein the structured dialog is enabled automatically such that at least one form is stored in a form library for customer or information system operator access.

20. System of claim 16 wherein the structured dialog robotically uses a sequence of fillable forms without operator or network controller involvement.

21. System of claim 16 wherein the structured dialog is automated adaptively or predictably according to a network-accessible dialog algorithm using customer data based on prior form input or option selection.

22. System of claim 16 wherein the structured dialog is enabled adaptively or predictably depending on information received and results of processing one or more application program interface (API).
